(19) United States
(12) Patent Application Publication
(10) Pub. No.: US 2021/0019042 A1
(43) Pub. Date: Jan. 21, 2021

(54) Vehicle and Controlling Method of the Same

(71) Applicants: Hyundai Motor Company, Seoul (KR); Kia Motors Corporation, Seoul (KR)

(72) Inventors: Jungmo Kwak, Gunpo-si (KR); Dong Won Yeon, Daejeon (KR); Myung Jun Kim, Busan (KR)

(21) Appl. No.: 16/702,683

(22) Filed: Dec. 4, 2019

(30) Foreign Application Priority Data
Jul. 19, 2019 (KR) 10-2019-0087482

(51) Int. Cl. G06F 3/0484; G06F 3/0488; B60N 2/56; B60H 1/00

(52) U.S. Cl. CPC G06F 3/04847; G06F 3/04886; G06F 2203/04803; B60N 2/5621; B60H 1/00985; B60N 2/5685

(57) ABSTRACT

A vehicle includes a first seat, a second seat, an HVAC system, and a touch screen configured to detect a user's touch and to display a setting interface of the HVAC system according to a plurality of seats. A controller is configured to convert the touch screen to a synchronization mode based on a first touch, to change the setting interface of the first seat and the setting interface of the second seat equally based on a second touch changing the setting interface of the first seat, and to control the HVAC system based on the changed setting interface.

### CROSS-REFERENCE TO RELATED APPLICATIONS

This application claims priority to Korean Patent Application No. 10-2019-0087482, filed in the Korean Intellectual Property Office on Jul. 19, 2019, which application is hereby incorporated herein by reference.

### TECHNICAL FIELD

The disclosure relates to a vehicle and a method of controlling the vehicle.

### BACKGROUND

The vehicle is equipped with an HVAC (Heating, Ventilation, &Air Conditioning) system that regulates the temperature of the air inside the vehicle and the purification of the air. In addition, the vehicle is provided with a function to independently control the divided area for each seat. For example, the three zone type divides the interior of the vehicle into three areas: a driver's seat, an auxiliary seat area, and a rear seat area, and controls the HVAC system to independently control the air temperature in each area.

In the conventional vehicle, the method of independently controlling the HVAC system is equipped with a plurality of physical buttons for air conditioning of the seat. If the driver wants to perform air conditioning for multiple seats while driving, the user is forced to push several input commands.

### SUMMARY

Embodiments relate to a touch screen that receives input commands from a vehicle's HVAC (Heating, Ventilation, & Air Conditioning) system.

In one aspect, the disclosure provides a vehicle and a control method of the vehicle to recognize predetermined touch inputs as SYNC commands, enable air conditioning of multiple seats with a simple touch, ensure the user's convenience and driving stability

In accordance with an aspect of the disclosure, a vehicle includes an HVAC systems. A touch screen detects a user's touch and displays a setting interface of the HVAC system according to a plurality of seats. A controller is configured to convert the touch screen to a synchronization mode based on a first touch, change the setting interface of the first seat and the setting interface of the second seat equally based on the second touch changing the setting interface of the first seat and control the HVAC system based on the changed setting interface.

The controller is configured to determine the first touch based on a plurality of touches input by the user

The touch screen is configured to divide and display the setting interface of the first seat and the second seat into symmetrical area.

The controller is configured to display a character interface on the touch screen in the synchronization mode or display a graphic interface on which the seat is coupled on the touch screen.

The controller is configured to adjust an indicator included in the setting interface of the second seat to correspond to an indicator of the setting interface of the first seat while adjusting the indicator of the setting interface of the first seat based on the second touch.

The controller is configured to display the setting interface of the first seat displayed on the touch screen in the synchronization mode as a setting interface for the driver's seat and change the setting interface of the second seat to at least one setting interface of a passenger seat or a rear seat.

The touch screen is configured to detect a third touch input to the area corresponding to the setting interface of the second seat, wherein the controller is configured to release the synchronization mode based on the third touch.

The HVAC system comprises at least one of an air conditioning device, a heating wire device, a ventilator or an air purification device, wherein the controller is configured to display the setting interface corresponding to each configuration of the HVAC system on the touch screen

The controller is configured to compare the second touch detected in the synchronization mode with a predetermined time and turn off the heating wire device and the ventilator of the first seat and the second seat based on the comparison result.

In accordance with an aspect of the disclosure, a control method is provided for a vehicle that includes an HVAC system and a touch screen to detect a user's touch. The method includes converting the touch screen to a synchronization mode based on a first touch, changing the setting interface of the first seat and the setting interface of the second seat equally based on the second touch changing the setting interface of the first seat, and controlling the HVAC system based on the changed setting interface.

The converting includes determining the first touch based on a plurality of touches input by the user.

The changing includes dividing and displaying the setting interface of the first seat and the second seat into symmetrical area.

The changing includes displaying a character interface on the touch screen in the synchronization mode or displaying a graphic interface on which the seat is coupled on the touch screen.

The changing includes adjusting an indicator or a color included in the setting interface of the second seat to correspond to an indicator or a color of the setting interface of the first seat while adjusting the indicator or the color of the setting interface of the first seat based on the second touch.

The control method includes displaying a character interface for changing a seat on the touch screen and changing the setting interface of the second seat to at least one setting interface of a passenger seat or a rear seat.

The control method includes detecting a third touch input to the area corresponding to the setting interface of the second seat and releasing the synchronization mode based on the third touch.

The HVAC system includes at least one of an air conditioning device, a heating wire device, a ventilator or an air purification device. The changing includes displaying the setting interface corresponding to each configuration of the HVAC system on the touch screen

The control method further includes comparing the second touch detected in the synchronization mode with a predetermined time and turning off the heating wire device and the ventilator of the first seat and the second seat based on the comparison result.

The controller is configured to determine the first touch based on a holding time for inputting a plurality of touches input by the user.

The controller is configured to display the color of the setting interface of the first seat and the color of the setting interface of the second seat differently, and change the color of the setting interface of the first seat and the color of the setting interface of the second seat based on the second touch when converting to the synchronization mode.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates an interior view of a vehicle according to an embodiment.

FIG. 2 is a view for explaining the problems of the prior art.

FIG. 3 is a control block diagram of a vehicle according to an exemplary embodiment.

FIG. 4 is a flowchart illustrating a control method according to an exemplary embodiment.

FIG. 5, which includes FIGS. 5A-5C, is an example of a touch screen operating in a synchronization mode.

FIG. 6, which includes FIGS. 6A-6C, is a view for explaining an embodiment of selecting a seat to control in the synchronization mode.

FIG. 7, which includes FIGS. 7A-7B, is a diagram for describing an embodiment in which a synchronization mode is released.

### DETAILED DESCRIPTION OF ILLUSTRATIVE EMBODIMENTS

Reference will now be made in detail to the embodiments of the present disclosure, examples of which are illustrated in the accompanying drawings, wherein like reference numerals refer to like elements throughout. It should be noted that the specification of the present disclosure does not describe all the constituent elements of the embodiments, and general matters well known to those skilled in the art and redundant matters of the embodiments will not be described herein for clarity.

Throughout the specification of the present disclosure, terms “..part”, “..module”, “..member”, “..block”, and the like mean an element capable of being implemented by hardware, software, or a combination thereof. As used in the specification and appended claims, the term “..parts”, “..modules”, “..members”, or “..blocks” maybe implemented by a single constituent element, or the term “..part”, “..module”, “..member”, or “..block” may include a plurality of constituent elements.

Throughout the specification of the present disclosure, if it is assumed that a certain part is connected (or coupled) to another part, the term “connection or coupling” means that the certain part is directly connected (or coupled) to another part and/or is indirectly connected (or coupled) to another part. Here, indirect connection (or indirect coupling) may conceptually include connection (or coupling) over a wireless communication network.

Throughout the specification of the present disclosure, if it is assumed that a certain part includes a certain component, the term “comprising or including” means that a corresponding component may further include other components unless context clearly indicates otherwise.

In description of the present disclosure, the terms “first” and “second” maybe used to describe various components, but the components are not limited by the terms. These terms may be used to distinguish one component from another component.

The terms “a”, “an”, “one”, “the” and other similar terms include both singular and plural forms, unless context clearly dictates otherwise.

Identification numbers for use in respective operations to be described later are used for convenience of description and better understanding of the present disclosure, do not describe the order or sequence of the respective operations of the present disclosure, and the respective operations of the present disclosure may be carried out in a different way from the order written in the present disclosure, unless context of each operation clearly indicates a specific order.

The principles of the present disclosure and the embodiments of the present disclosure will hereinafter be given with reference to the attached drawings.

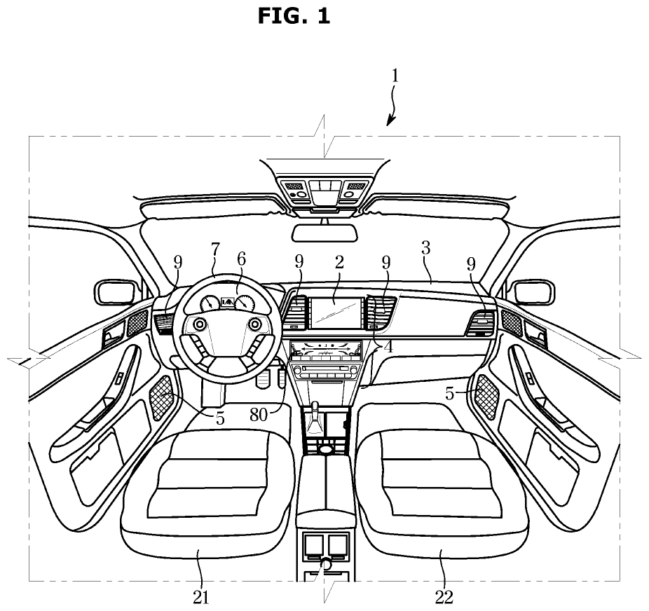

FIG. 1 illustrates an interior view of a vehicle according to an embodiment.

Referring to FIG. 1, an audio video navigation (AVN) display 2 of the vehicle 1 may be provided in the center fascia 4 of the vehicle front dashboard 3 so that an user, in particular, the driver, can see or manipulate the displayed image while driving. The center fascia 4 means a central area of the dashboard 3 located between the driver's seat 21 and the passenger seat 22.

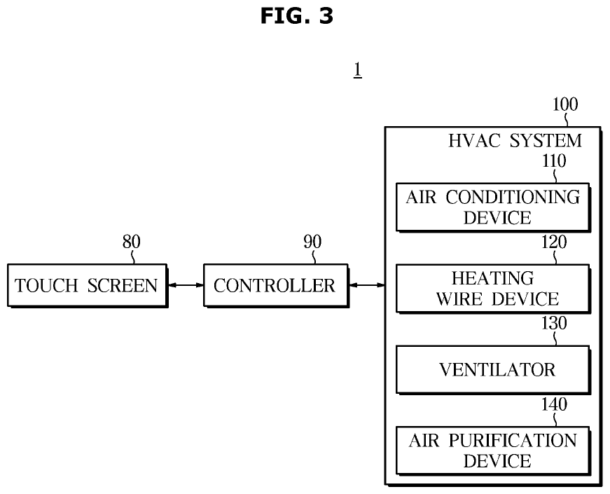

The AVN display 2 may display various images provided by the controller 90 (refer to FIG. 3), for example, a map image including a GPS signal indicating a current position of the vehicle 1, and an image selected by the user. The speaker 5 may output a sound together with the image displayed by the AVN display 2. The AVN display 2 may be implemented as a liquid crystal display (LCD), a light emitting diode (LED), a plasma display panel (PDP), an organic light emitting diode (OLED), a cathode ray tube (CRT), or the like.

The cluster 6 may be provided in an area facing the steering wheel 7 of the area of the dashboard 3 so that the driver can check the instrument panel while driving. The cluster 6 may provide the user with status information such as the speed of the vehicle, the fuel gauge, and the like. The cluster 6 may be provided in the form of a physical instrument panel, but may be implemented as a liquid crystal display (LCD), a light emitting diode (LED), a plasma display panel (PDP), an organic light emitting diode (OLED), a cathode ray tube (CRT), and the like as an AVN display.

Meanwhile, the disclosed vehicle 1 may further include a touch screen 80 in the central region of the center fascia 4 in addition to the AVN display 2 and the cluster 6. The touch screen 80 is a device that receives a user's command for the HVAC system 100 (see FIG. 3). The touch screen 80 detects a user's touch, converts a setting interface corresponding to the touched area into an electrical signal, and transmits the signal to the controller 90. A detailed description of the touch screen 80 will be described later with reference to the accompanying drawings.

The HVAC system 100 refers to a set of devices for integrating heating, ventilation, and cooling to regulate an environment inside the vehicle 1. The HVAC system 100 discharges the cooled air through the air conditioning device 110 (see FIG. 3) through the vent hole 9 or the purified air through the air purification device 140 (see FIG. 3). In addition, the HVAC system 100 may further include a heating wire device 120 or a ventilator 130 provided in the driver's seat 21 and the auxiliary seat 22.

The vehicle 1 may further include various devices in addition to the above-described configuration, and is not necessarily limited to the position shown in FIG. 1. For example, when the AVN display 2 is implemented as a touch screen panel, the touch screen 80 may be configured integrally with the AVN display to receive a user's command regarding the operation of the HVAC system 100.

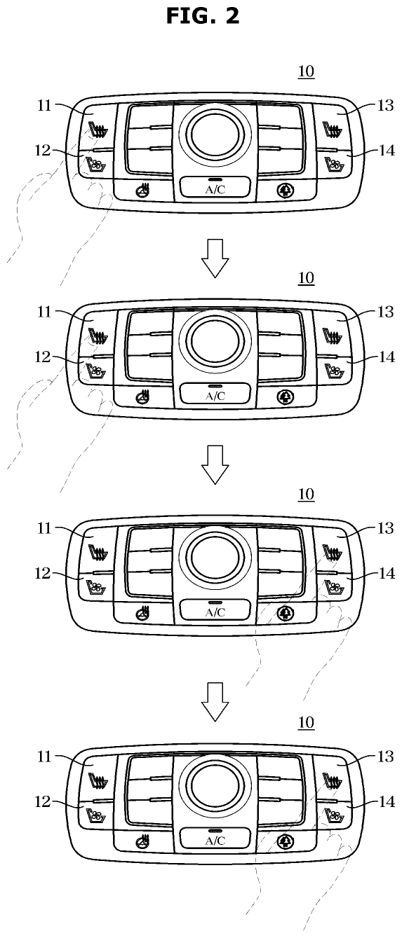

FIG. 2 is a view for explaining the problems of the prior art.

Referring to FIG. 2, the conventional vehicle has received a user's command for operating the HVAC system through the input unit 10 including the physical push buttons 11 to 19.

For example, the input unit 10 includes push buttons 11 and 12 for controlling the heating wire device and the ventilator for the driver's seat 21, and a push button 13 and 14 for controlling the heating wire device and the ventilator for the auxiliary seat 22.

If the user wants to raise the level of the heating wire device of the two seats 21 and 22 from 0 to 2, the user has to push the first push button 11 twice and the second push button 13 twice. This operation forces the driver to make a total of four button operations, and may be a problem in the driving stability and convenience.

FIG. 3 is a control block diagram of a vehicle according to an exemplary embodiment.

Referring to FIG. 3, the vehicle 1 detects a user's intention through a touch screen 80 that detects a user's touch and a detection result of the touch screen 80, and includes a controller 90 that controls the vehicle 1 as a whole and an HVAC system 100 that controls an environment inside the vehicle 1.

The touch screen 80 may be configured as a touch screen panel (TSP) and a display panel displaying various user interfaces.

The touch screen panel acts as an input device that detects a user's touch. If the user presses or touches the screen with a finger or a touch pen, the touch screen panel detects the position and pressure of the touched area and generates an electrical signal.

In more detail, the touch screen panel may include a touch panel, a controller IC, a driver SW, and the like. The touch panel may be formed of an upper plate and a lower plate (Film or Glass) on which a transparent electrode (Indium Tin Oxide, ITO) is deposited. When a contact occurs in the transparent electrode, the touch panel detects a signal generation position according to the change in the capacitance. Thereafter, the touch panel transmits signal generation position information to the controller IC. The controller IC converts the analog signal transmitted from the transparent electrode into a digital signal and converts it into a coordinate form that can be displayed on the screen. Driver SW is a program that controls the touch panel to be implemented for each operating system by receiving the digital signal from the controller IC.

The touch screen panel may be classified into a resistive film type, a capacitive type, an ultrasonic wave type, an infrared ray type, and an optical type according to an applied technology. The touch screen panel according to an embodiment may be applied with the above-described technology.

The display panel may apply various display implementation methods described above with reference to FIG. 1. The user interface displayed by the display panel includes various setting interfaces regarding the functionality of the HVAC system 100. In addition, the user interface may be designed in the form of a seat or in the form of letters for the user's understanding, and displayed on the display panel. Various embodiments displayed by the display panel will be described later with reference to other drawings below.

The controller 90 controls the vehicle 1 as a whole.

The controller 90 determines whether to convert to the synchronization mode based on the electrical signal transmitted by the touch screen 80. Here, the synchronization mode refers to an operation of changing the setting of the remaining seats by only changing the setting of one of the plurality of seats provided in the vehicle. In the synchronization mode, the touch screen 80 changes the setting interface to be the same or corresponding to each seat according to the user's touch. The controller 90 controls the HVAC system 100 according to the input command of the user. Specific embodiments in which the controller 90 controls the touch screen 80 and the HVAC system 100 will be described later with reference to other drawings.

The controller 90 may be implemented by a memory (not shown) that stores an algorithm for controlling the operation of the components in the vehicle 1 or data for a program that reproduces the algorithm and a processor (not shown) that performs the above-described operation using data stored in a memory. In this case, the memory and the processor may be implemented as separate chips. Alternatively, the memory and the processor may be implemented in a single chip.

The HVAC system 100 may include an air conditioning device 110, a heating wire device 120 provided in each of a plurality of seats, a ventilator 130 that emits cold air inside the seat, and an air purification device 140 that purifies the air inside the vehicle 1.

The air conditioning device 110 is a device for controlling the temperature of the air inside the vehicle 1 and maybe composed of a condenser, a compressor, an evaporator, and an expander. The air conditioning device 110 compresses and circulates the refrigerant in the refrigerant circuit to heat or cool the ambient air of the condenser and discharge the heated/cooled air through the vent hole 9.

The heating wire device 120 may be provided with a plurality of heating wires inside the seat, and generates heat by receiving a current under the control of the controller 90. Heating wires maybe made from a combination of two or more materials.

The ventilator 130 may include, for example, an air circulation passage through which air can be circulated inside the seat of the vehicle 1, and a fan capable of circulating air into the air circulation passage. The fan may also be configured to circulate air inside the seat in association with the air conditioning device 110. In addition, the cover of the seat (21, 22) is provided in a porous structure, it is possible to emit air to the user seated in the seat (21, 22).

The air purification device 140 includes a sensor for detecting an air quality state inside the vehicle 1 and a filter for purifying inhaled air. The filter may be connected to the air conditioning device 110 to discharge the purified air into the vehicle 1.

The HVAC system 100 may further include various configurations in addition to the above, and it is sufficient to operate under the control of the controller 90.

Meanwhile, at least one component may be added or deleted to correspond to the performance of the components described with reference to FIG. 3. In addition, the mutual position of the components can be changed corresponding to the performance or structure of the system.

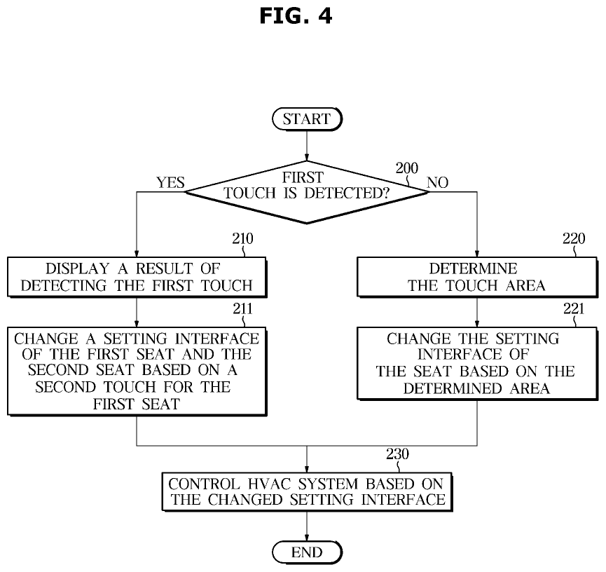

FIG. 4 is a flowchart illustrating a control method according to an exemplary embodiment.

Referring to FIG. 4, the touch screen 80 detects a first touch of a user (200).

Here, the first touch means that the user simultaneously touches at least two areas divided according to each seat on the touch screen 8o. The touch screen 80 according to an embodiment displays a setting interface for operating the configuration of the HVAC system 100 provided according to each seat, and the setting interface may be divided into a predetermined area and react to the user's touch. Accordingly, the touch screen 80 may be divided into corresponding areas for each seat, and the first touch is set to simultaneously touch at least two areas.

In the first touch, an area of the touch screen 80 for each seat may include a plurality of touches at about the same time. When a plurality of sequential touches that are not at the same time are detected, if a plurality of touches are detected in each area for more than a predetermined holding time, the touches may correspond to first touch. Here, the plurality of touches are touches that are simultaneously or sequentially input to one point of two or more regions corresponding to left/right or up/down symmetry. The plurality of touches of left/right or up/down symmetry is not limited in order.

The first touch may include a case where three or more touches are simultaneously input. When two or more touches are detected in the areas divided according to the seats, the touches may correspond to first touch.

When the touch screen 80 detects the first touch, the controller 90 displays the result of detecting the first touch on the touch screen 80 (210), and changes a setting interface of the first seat and the second seat based on the second touch for the first seat (211).

In detail, when the first touch is detected, the controller 90 determines the first touch as a command for instructing to convert to the synchronization mode. Accordingly, the controller 90 converts the touch screen 80 to the synchronization mode.

The controller 90 may display a character interface on the touch screen 80 or display a graphic interface in which a seat is coupled to display a conversion to the synchronization mode to the user.

After entering the synchronization mode, the touch screen 80 detects the user's second touch. Here, the second touch refers to a user's input detected after a predetermined time after entering the synchronization mode. The second touch may be detected regardless of the area of the touch screen 80 divided according to the seat. The controller 90 determines a setting interface corresponding to the area where the second touch is detected. For example, the area where the second touch is detected may be a setting interface corresponding to a setting value for raising the heating level of the first seat. In this case, the controller 90 raises the heating level of the first seat as well as the heating level of the synchronized second seat together. That is, the controller 90 changes the value or bar of the setting interface indicating the heating wire level displayed on the touch screen 80.

On the other hand, if the touch screen 80 does not detect the first touch, the controller 90 does not convert the touch screen 80 into synchronization mode. Thereafter, the controller 90 controls the touch screen 80 to the general operation mode before synchronization. That is, the controller 90 determines the user's touch area (220) and changes the setting interface of the seat based on the determined area (221).

In general operation mode other than the synchronization mode, the user can input for each seat to control the set value of the HVAC system (100). The controller 90 determines the seat to be controlled by the user by determining the touch area. The controller 90 checks the setting interface corresponding to the touched area, and determines the setting value of the HVAC system 100 according to the input number of touches. The controller 90 changes the setting interface of the seat based on the determined setting value. This change is only for the setting interface included in the seat corresponding to the area touched by the user, except for the setting interface of the other seats.

The controller 90 controls HVAC system 100 based on the changed setting interface (230).Specifically, the controller 90 determines the configuration of the HVAC system 100 corresponding to the changed setting interface, and controls the configuration of the HVAC system 100 determined according to the determined setting value.

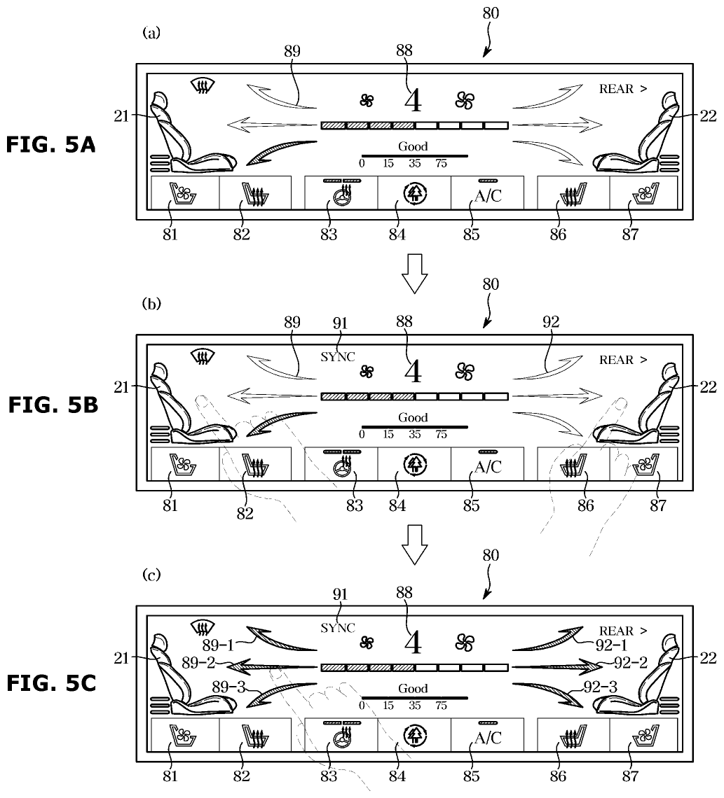

FIG. 5 is an example of a touch screen operating in a synchronization mode.

The touch screen 80 displays various graphical user interfaces (GUIs) provided symmetrically to allow the user to control the HVAC system 100 for at least two seats 21, 22. Here, the various GUIs can display a plurality of setting interfaces 81 to 89 relating to setting values of the HVAC system 100. The touch screen 80 of FIG. 5 to FIG. 7 is illustrated in a symmetrical structure corresponding to two seats, but is not necessarily limited thereto.

Referring to FIG. 5A, the touch screen 80 may display, a first setting interface 81 for controlling the ventilator 130 of the designed driver's seat 21, a second setting interface 82 for controlling the heating wire device 120 of the driver's seat 21, a third setting interface 83 for controlling the provided heating wire device 120 of the steering wheel 7, a fourth setting interface 84 corresponding to the operation start command of the air purification device 140 and a fifth setting interface 85 for adjusting the on/off and wind strength of the air conditioning device 11o. The touch screen 80 may display a sixth setting interface 86 for controlling the heating wire device 120 of the designed auxiliary seat 22 and a seventh setting interface 87 for controlling the ventilator 130 of the auxiliary seat 22.

The upper region higher than the region in which the plurality of setting interfaces 81 to 87 are provided may display the setting interfaces 88 and 89 representing the setting values of the air conditioning device 110 as well as the designed seats 21 and 22. Specifically, the touch screen 80 may display a seventh setting interface 88 displaying a desired temperature 4 as a reference for the operation of the air conditioning device 110, and an eighth setting interface 89 which leads to the selection of the vent hole 9 for air conditioning device (110) to discharge the air. Here, the eighth setting interface 89 may be displayed in a predetermined area so as to be distinguished for each seat.

Referring to FIG. 5B, the user inputs first touch. That is, the user simultaneously touches a region corresponding to the driver's seat 21 and the auxiliary seat 22.

The controller 90 displays a first character interface SYNC 91 on the touch screen 80 to convey information that the touch screen 80 has been converted to the synchronization mode.

On the other hand, the area where the first touch is made is not limited to only one area of the designed driver's seat 21 and the designed auxiliary seat 22 shown in FIG. 5B. The controller 90 may determine the first touch even if a simultaneous touch is input to the display portion corresponding to the independent control area for each seat, for example, the eighth setting interface 89 and the ninth setting interface 92 of the driver's seat 21.

Referring to FIG. 5C, in the synchronization mode, the user may touch the eighth setting interface 89. In addition, the user may input the second touch several times, and the controller 90 determines two second touches.

Based on the determination result of the controller 90, the touch screen 80 changes colors of the remaining eighth setting interfaces 89-2 and 89-1 other than the eighth setting interface 89-3 corresponding to the lower indicator among the three indicators. The controller 90 also changes the ninth setting interfaces 92-1, 92-2, 92-3 of the auxiliary seat 22.

The controller 90 may display the colors of the indicators of the driver's seat 21 and the auxiliary seat 22 in different colors while the synchronization mode is released. When entering the synchronization mode, the controller 90 may change the color of the indicator of the auxiliary seat 22 to the color of the indicator of the driver's seat 21 and then display the same color on the touch screen 80.

The controller 90 controls the entire vent hole 9 for discharging the air cooled by the air conditioning device 110 toward the driver's seat 21 and the auxiliary seat 22.

In the embodiment of FIG. 5C, the user may long touch the area of the touch screen 80 on which the designed driver's seat 21 is displayed. Here, the long touch means that the user's second touch is detected more than a predetermined time. The controller 90 may compare the area where the second touch is detected with a predetermined time and determine the second touch as a long touch. In this case, the touch screen 80 may turn off the heating wire device 120 and the ventilator 130 of the driver's seat 21 and the synchronized auxiliary seat 22.

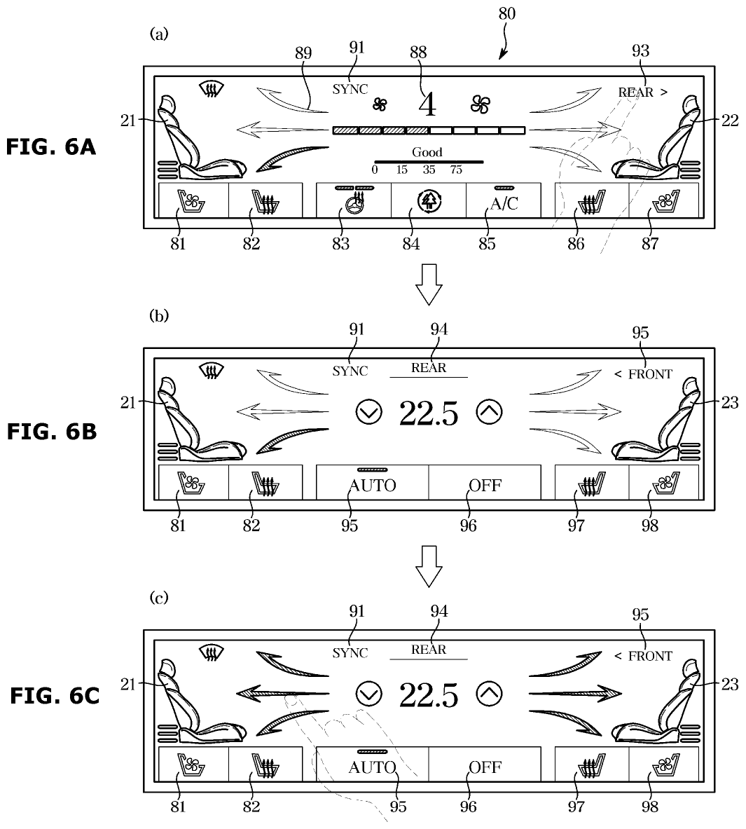

FIG. 6 is a view for explaining an embodiment of selecting a seat to control in the synchronization mode.

Referring to FIG. 6A, the touch screen 80 is operating in a synchronization mode. As an example, the touch screen 80 may display an object that can be controlled together with the setting interface of the driver's seat 21, that is, the setting interface of the auxiliary seat 22. However, the touch screen 80 may display an interface for inducing a seat change as a second character interface REAR 93 on the upper right side of the screen in order to indicate to the user that the seat corresponding to the current synchronization mode is an auxiliary seat 22.

In the synchronization mode, the user may touch an area corresponding to the second character interface 93.

Referring to FIG. 6B, the touch screen 80 may change the seat to be synchronized to the rear seat 23 according to the above-described user command. In this case, the touch screen 80 may display a third character interface 94 that can indicate to the user that the seat that can be currently synchronized is the rear seat 23 in the upper center area of the screen.

The touch screen 80 may modify the setting interface screen to fit the HVAC system 100 provided in the rear seat 23. For example, although the ventilator 130 and the air purification device 140 are provided in the rear seat 23 of the vehicle 1, the air purification device 140 may not be provided separately. In addition, since the steering wheel 7 is not provided in the rear seat 23, the synchronized command cannot be displayed. Therefore, in the current mode in which the driver's seat 21 and the rear seat 23 may be synchronized, the touch screen 80 may display a first setting interface 81, a second setting interface 82, a tenth setting interface 95 for adjusting the automatic/manual mode of the air conditioning device 110, an eleventh setting interface 96 for controlling whether the air conditioning device 110 is operated, a twelfth setting interface 97 for controlling the heating wire device 120 of the rear seat 23, a thirteenth setting interface 98 for controlling the ventilator 130 of the rear seat 23.

The touch screen 80 may display an interface for inducing a seat change as a fourth character interface FRONT 95 on the upper right side of the screen.

Referring to FIG. 6C, the user also controls the HVAC system 100 of the synchronized rear seat 23 by touching the setting interface 81, 82, 85, 89, which can adjust the HVAC system 100 of the driver's seat 21.

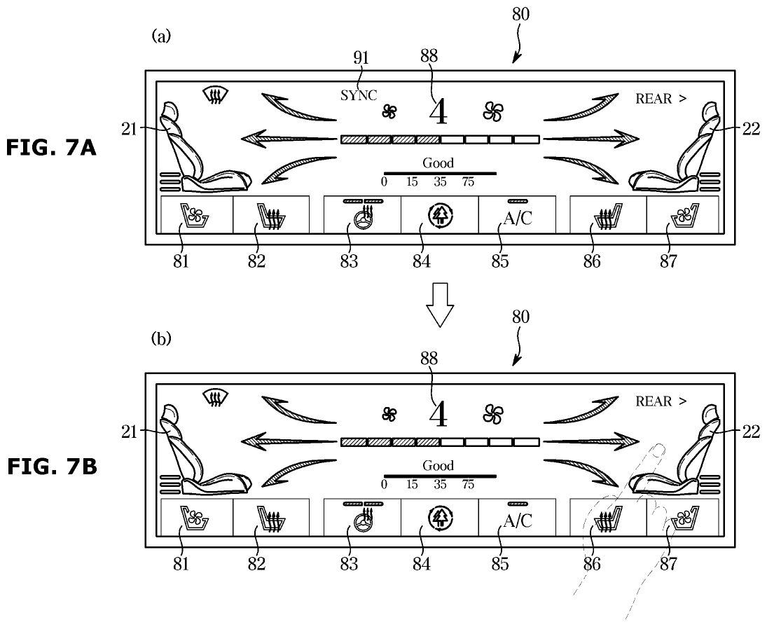

FIG. 7 is a diagram for describing an embodiment in which a synchronization mode is released.

Referring to FIG. 7A, the touch screen 80 is operating in synchronization mode. In the synchronization mode, the user may also control the HVAC system 100 of the synchronized auxiliary seat 22 by touching the setting interface 81, 82, 85, 89 which can adjust the HVAC system 100 of the driver's seat 21. In addition, as described above in FIG. 5, in the synchronization mode, the touch screen 80 may display the character interface 91 Indicating to the user that the current mode is the synchronization mode.

Referring to FIG. 7B, to turn off synchronization mode, the user may touch a region of the touch screen 80 where the setting interface 86, 87 which can control only the auxiliary seat 22 or the designed auxiliary seat 22 is located. The controller 90 may release the synchronization mode by the third touch and display an image in which the character interface 91 is deleted.

When the synchronization mode is released, even if the user touches the setting interface 81, 82, 85, 89 for controlling the driver's seat 21, the controller 90 does not control the devices of the HVAC system 100 controlling the auxiliary seat 22.

Meanwhile, the screen of the touch screen 80 described with reference to FIGS. 5 to 7 is merely an example. Unlike FIG. 5 to FIG. 7, the touch screen 80 may display a setting interface for all seats included in the vehicle 1 on one screen, and synchronize all seats other than the driver's seat together due to the first touch. In this case, the screen of the touch screen 80 may be configured as a screen different from the screen shown in FIGS. 5 to 7.

The vehicle and a control method of the vehicle according to an aspect of the disclosure may recognize predetermined touch inputs as SYNC commands, enable air conditioning of multiple seats with a simple touch, ensure the user's convenience and driving stability.

The vehicle and a control method of the vehicle according to another aspect of the disclosure may recognize a synchronization mode to a user through various setting interfaces, thereby improving the degree of freedom of design that may be included in a touch screen with the omission of a physical SYNC button.

What is claimed is:

1. A vehicle comprising:
a first seat and a second seat;
an HVAC (heating, ventilation, and air conditioning) system;
a touch screen configured to detect a user's touch and to display a setting interface of the HVAC system according to a plurality of seats; and
a controller configured to convert the touch screen to a synchronization mode based on a first touch, to change the setting interface of the first seat and the setting interface of the second seat equally based on a second touch changing the setting interface of the first seat, and to control the HVAC system based on the changed setting interface.

2. The vehicle according to claim 1, wherein the controller is configured to determine the first touch based on a plurality of touches input by the user.

3. The vehicle according to claim 1, wherein the touch screen is configured to divide and display the setting interface of the first seat and the second seat into symmetrical areas.

4. The vehicle according to claim 1, wherein the controller is configured to display a character interface on the touch screen in the synchronization mode or display a graphic interface on which the first seat is displayed on the touch screen.

5. The vehicle according to claim 1, wherein the controller is configured to adjust an indicator included in the setting interface of the second seat to correspond to an indicator of the setting interface of the first seat while adjusting the indicator of the setting interface of the first seat based on the second touch.

6. The vehicle according to claim 1, wherein the controller is configured to display the setting interface of the first seat displayed on the touch screen in the synchronization mode as a setting interface for a driver's seat and to change the setting interface of the second seat as a setting interface of a passenger seat or a rear seat.

7. The vehicle according to claim 1, wherein the touch screen is configured to detect a third touch input to an area corresponding to the setting interface of the second seat; and
wherein the controller is configured to release the synchronization mode based on the third touch input.

8. The vehicle according to claim 1, wherein the HVAC system comprises an air conditioning device, a heating wire device, a ventilator or an air purification device; and
wherein the controller is configured to display the setting interface corresponding to each configuration of the HVAC system on the touch screen.

9. The vehicle according to claim 8, wherein the controller is configured to compare the second touch detected in the synchronization mode with a predetermined time and to turn off the heating wire device or the ventilator of the first seat and the second seat based on a result of the comparison.

10. The vehicle according to claim 1, wherein the controller is configured to determine the first touch based on a holding time for inputting a plurality of touches input by the user.

11. The vehicle according to claim 1, wherein the controller is configured to display a color of the setting interface of the first seat and a color of the setting interface of the second seat differently, and to change the color of the setting interface of the first seat and the color of the setting interface of the second seat based on the second touch when converting to the synchronization mode.

12. A method of controlling a vehicle that comprises an HVAC (heating, ventilation, and air conditioning) system and a touch screen, the method comprising:
converting the touch screen to a synchronization mode based on a first touch;
changing a setting interface of a first seat and a setting interface of a second seat equally based on a second touch changing the setting interface of the first seat; and
controlling the HVAC system based on the changed setting interface.

13. The method according to claim 12, wherein the converting determining the first touch based on a plurality of touches input by a user.

14. The method according to claim 12, wherein the changing comprises dividing and displaying the setting interface of the first seat and the second seat into symmetrical areas.

15. The method according to claim 12, wherein the changing comprises displaying a character interface on the touch screen in the synchronization mode or displaying a graphic interface on which the first seat is displayed on the touch screen.

16. The method according to claim 12, wherein the changing adjusting an indicator or a color included in the setting interface of the second seat to correspond to an indicator or a color of the setting interface of the first seat while adjusting the indicator or the color of the setting interface of the first seat based on the second touch.

17. The method according to claim 12, further comprising:
displaying a character interface for changing a seat on the touch screen; and
changing the setting interface of the second seat to a setting interface of a passenger seat or a rear seat.

18. The method according to claim 12, further comprising:
detecting a third touch input to an area corresponding to the setting interface of the second seat; and
releasing the synchronization mode based on the third touch input.

19. The method according to claim 12, wherein the HVAC system comprises an air conditioning device, a heating wire device, a ventilator or an air purification device; and
wherein the changing comprises displaying the setting interface corresponding to each configuration of the HVAC system on the touch screen.

20. The method according to claim 19, further comprising:
comparing the second touch detected in the synchronization mode with a predetermined time; and
turning off the heating wire device or the ventilator of the first seat and the second seat based on a result of the comparison.
